(19) United States
(12) Patent Application Publication
(10) Pub. No.: US 2023/0189144 A1
(43) Pub. Date: Jun. 15, 2023

(54) PROCESSING METHOD AND APPARATUS

(71) Applicant: VIVO MOBILE COMMUNICATION CO., LTD., Dongguan (CN)

(72) Inventors: Siqi LIU, Dongguan (CN); Zichao JI, Dongguan (CN); Shixiao LIU, Dongguan (CN)

(73) Assignee: VIVO MOBILE COMMUNICATION CO., LTD., Dongguan (CN)

(21) Appl. No.: 18/105,840

(22) Filed: Feb. 4, 2023

Related U.S. Application Data
(63) Continuation of application No. PCT/CN2021/110897, filed on Aug. 5, 2021.

(30) Foreign Application Priority Data
Aug. 5, 2020 (CN) 202010779466.1

(51) Int. Cl. H04W 52/02; H04W 72/25

(52) U.S. Cl. CPC H04W 52/0216; H04W 72/25

(57) ABSTRACT

A processing method and apparatus are provided. The method includes: obtaining a first configuration, where the first configuration includes one or more active times.

### CROSS-REFERENCE TO RELATED APPLICATIONS

This application is a continuation of International Application No. PCT/CN2021/110897, filed on Aug. 5, 2021, which claims priority to Chinese Patent Application No. 202010779466.1, filed on Aug. 5, 2020. The entire contents of each of the above-identified applications are expressly incorporated herein by reference.

### TECHNICAL FIELD

This application relates to the technical field of communication, and in particular, to a processing method and apparatus.

### BACKGROUND

To save power, a Sidelink (SL) introduces SL Discontinuous Reception (DRX) to control SL sending and/or receiving. The SL further introduces partial sensing to save power. Because an arriving packet is dynamic, a location of a partial sensing pattern changes dynamically in real time as the arriving packet changes. This may cause a mismatch between partial sensing and a DRX active time, for which a user cannot normally implement sensing and resource selection.

Refer to FIG. 1. A user implements, based on a sensing result in a partial sensing window ½, resource selection or reselection in a selection window. However, because the partial sensing window ½ is not within an active time that can be used for receiving, in this case, the user actually cannot receive Sidelink Control Information (SCI) in the partial sensing window ½, and thus cannot implement sensing. Consequently, a result of resource selection or reselection is seriously affected.

### SUMMARY

The embodiments of this application provide a processing method and apparatus.

A first aspect provides a processing method, applied to a first terminal, and including:

obtaining a first configuration, where the first configuration includes one or more active times.

A second aspect provides a configuration apparatus, applied to a first terminal, and including:

an obtaining module, configured to obtain a first configuration, where the first configuration includes one or more active times.

A third aspect provides a terminal, including a processor, a memory, and a program that is stored in the memory and that can be run by the processor, where when the program is executed by the processor, the steps of the method according to the first aspect are implemented.

A fourth aspect provides a readable storage medium. The readable storage medium stores a program or an instruction, and when the program or the instruction is executed by a processor, the steps of the method according to the first aspect are implemented.

A fifth aspect provides a readable storage medium. The readable storage medium stores a program or an instruction, and when the program or the instruction is executed by a processor, the steps of the processing method according to the first aspect are implemented.

A sixth aspect provides a computer program product. The program product is stored in a non-volatile storage medium. The program product is executed by at least one processor to implement the steps of the processing method according to the first aspect.

A seventh aspect provides a chip. The chip includes a processor and a communication interface, the communication interface is coupled to the processor, and the processor is configured to run a program or an instruction to implement the processing method according to the first aspect.

### BRIEF DESCRIPTION OF DRAWINGS

FIG. 1 is a schematic diagram of a mismatch between a sensing time and an active time in a conventional technology;

FIG. 2 is a block diagram of a wireless communication system to which an embodiment of this application is applicable;

FIG. 3 is a flowchart of a processing method according to an embodiment of this application;

FIG. 4 is a schematic diagram of a match between an active time and a sensing time, and a selection time according to an embodiment of this application:

FIG. 5 is a schematic diagram of a first configuration based on the logical time and the physical time according to an embodiment of this application:

FIG. 6 is a schematic diagram of embodiment 1 according to an embodiment of this application:

FIG. 7 is a schematic diagram of embodiment 2 according to an embodiment of this application:

FIG. 8 is a schematic diagram of embodiment 3 according to an embodiment of this application;

FIG. 9 is a schematic diagram of embodiment 4 according to an embodiment of this application;

FIG. 10 is a schematic diagram of embodiment 5 according to an embodiment of this application:

FIG. 11 is a schematic diagram of a processing apparatus according to an embodiment of this application; and

FIG. 12 is a schematic diagram of a terminal according to an embodiment of this application.

### DETAILED DESCRIPTION

Transmission in embodiments of this application can be understood as receiving and/or sending.

A manner of obtaining all information mentioned in the embodiments of this application may be that: by configuration of a base station, user equipment being scheduled to schedule or indicate, preconfiguring, negotiating between user equipment, stipulating in a protocol, determining by user equipment, or the like.

A time length in the embodiments of this application may be understood as an included time domain resource quantity, measurable resource quantity, physical resource quantity, and/or logical resource quantity.

A resource mentioned in the embodiments of this application includes a time domain and/or frequency domain resource. The frequency domain resource may be one or more, (on one or more time domain resources), sub-channels or Resource Blocks (RBs), RB groups, interlaces, or transmission combs (combs). The time domain resource may be one or more symbols/slots/mini-slots/milliseconds (ms)/subframes/frames/periodicities/Channel Occupancy Time (COT). The time domain resource is the physical time domain resource, or may be the logical time domain resource. For example, a slot may be a physical slot, or may be a logical slot. The time domain resource may be a single slot resource occupying X sub-channels or RBs.

The measurable resource may be a (logical) resource within an active time (corresponding to receiving or sending) that preferably is at least an active time for receiving through a control channel or data channel, for example, an active time for receiving through a Physical Sidelink Control CHannel (PSCCH) and/or a Physical Sidelink Shared CHannel (PSSCH).

A non-measurable resource may be a resource within an inactive time that is at least an inactive time for receiving through a control channel or data channel, for example, an inactive time for receiving through a PSCCH and/or a PSSCH.

In the embodiments of this application, a ratio of A to B may be A+B, or may be B+A.

A first configuration in the embodiments of this application may also be referred to as a first configuration pattern. For example, the first configuration may be an SL DRX configuration. A second configuration may also be referred to as a second configuration pattern. For example, the second configuration may be a partial sensing configuration, or may be a sensing configuration. In the embodiments of this application, only partial sensing is used as an example, but this is not limited to partial sensing and can be applied to full sensing as well.

The first configuration in this specification may be divided into an active time and/or an inactive time. Within the active time, a user measures, monitors, and/or transmits a target object, while within an inactive time, the user does not measure, monitor, and/or transmit the target object.

The active time and the inactive time may be defined to the target object, that is, active times for different target objects may be the same or may be different, and inactive times for different target objects may be the same or may be different.

The active time and the inactive time may be defined to a transmission direction, that is, active times for sending and receiving may be the same or may be different, and inactive times for sending and receiving may be the same or may be different. For some target objects or transmission directions, there may be only an active time, without an inactive time.

For example, in an assumption, SCI may be sent at any time.

For example, control and/or data receiving is/are limited to a DRX active time, but control and/or data sending may be performed within an inactive time corresponding to receiving or an inactive time, and in some implementations, control and/or data sending is/are limited to a selection window.

The active time includes at least one of On duration (on-duration, or onDuration), an on duration timer, a DRX-inactivity timer (drx-InactivityTimer), a DRX-retransmission timer (drx-RetransmissionTimer), a T400 runtime, and sl-LatencyBoundCSI-Report duration. The active time may also be explained as a time within which one or some or all signals and/or channels can be sent and/or received.

The inactive time includes at least one of Off duration (off-duration, or off-Duration), a Round Trip Time (RTT), a timer runtime, a non-partial sensing window part (for example, a part between two partial sensing windows or a disabled partial sensing window), and a non-sensing time.

Resource determining in the embodiments of this application may include resource selection, resource reselection, resource estimation, and/or resource re-estimation.

The following describes the embodiments of this application with reference to the accompanying drawings in the embodiments of this application. Apparently, the described embodiments are some but not all of the embodiments of this application.

In the description and the claims of this application, the terms “first,” “second,” and the like are intended to distinguish between similar objects but do not describe a specified order or sequence. It should be understood that, data used in this way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that the technology described in the embodiments of this application is not limited to a Long Term Evolution (LTE)/LTE-Advanced (LTE-A) system, and may also be used in various wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The described technologies can be applied to both the systems and the radio technologies mentioned above as well as to other systems and radio technologies. However, a New Radio (NR) system is described below as an example, and the term NR is used in most of the descriptions, although these technologies can also be used in an application other than an application of the NR system, for example, a 6th Generation (6G) communication system.

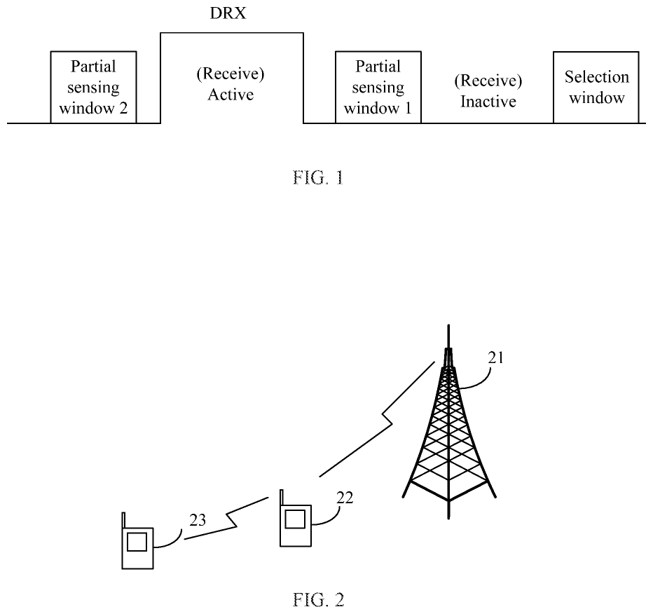

FIG. 2 is a block diagram of a wireless communication system to which an embodiment of this application can be applied. The wireless communication system includes a terminal 21 and a network side device 22. The terminal 21 may also be referred to as a terminal device or User Equipment (UE). The terminal 21 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), a wearable device or a Vehicle User Equipment (VUE), or a Pedestrian User Equipment (PUE). The wearable device includes a band, a headset, eyeglasses, or the like. It should be noted that a specific type of the terminal 21 is not limited in the embodiments of this application. The network side device 22 may be a base station or a core network. The base station may be referred to as a NodeB, an evolved Node B, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmitting Receiving Point (TRP), or another suitable term in the field provided. The base station is not limited to a specified technical term. It should be noted that, in the embodiments of this application, only a base station in an NR system is used as an example, but a specific type of the base station is not limited.

The processing method and apparatus provided in the embodiments of this application are described in detail below with specific embodiments and application scenarios thereof in conjunction with the accompanying drawings.

Refer to FIG. 3. This embodiment of this application provides a configuration method. The method may be performed by a first terminal and includes step 301.

Step 301: obtaining a first configuration, where the first configuration includes one or more active times.

In this embodiment of this application, the method may further include: determining a second configuration based on the first configuration, where the second configuration includes a sensing time and/or a selection time.

The sensing time may also be referred to as a sensing window, and clearly, is not limited to this. The selection time may also be referred to as a selection window, and clearly, is not limited to this.

In this embodiment of this application, a periodicity of the first configuration is a common multiple (for example, a greatest common multiple) or a common divisor (for example, a least common divisor) of a first periodicity; or a periodicity of the first configuration corresponds to a first periodicity; or a periodicity of the first configuration corresponds to a first periodicity range.

The first periodicity includes at least one of the following:

(1) A reservation periodicity.

The reservation periodicity may be at least one of reserved periodicities that are obtained, selected, indicated in a received signal or channel, or of a packet, a Media Access Control Protocol Data Unit (MAC PDU), a Transport Block (TB), or data to be sent currently, for example, a reservation periodicity of a resource in a resource pool.

For example, a configuration has a plurality of reserved periodicities, and a first periodicity is determined based on one or more or all of the plurality of reserved periodicities.

(2) A sensing periodicity and/or step size.

The sensing periodicity and/or step size may be at least one of sensing periodicities and/or step sizes that are obtained, selected, indicated in a received signal or channel, or of a packet, a MAC PDU, a TB, or data to be sent currently.

For example, a configuration has a plurality of sensing periodicities and/or step sizes, and a first periodicity is determined based on one or more or all of the plurality of sensing periodicities and/or step sizes.

(3) A feedback resource periodicity, for example, a periodicity, N_PSFCH=1/2/4, of a Physical Sidelink Feedback CHannel (PSFCH).

For example, a configuration has a plurality of feedback resource periodicities, and a first periodicity is determined based on one or more or all of the plurality of feedback resource periodicities.

In the embodiments of this application, the plurality of active times at least include a first active time and a second active time.

In some implementations, the first active time may include one or more of first DRX On duration 1, a first inactivity timer, and a first retransmission timer.

In some implementations, the second active time may include one or more of second DRX duration, a second inactivity timer, and a second retransmission timer.

In this embodiment of this application, the first active time is used for receiving and/or sending; and/or the second active time is used for receiving and/or sending.

In this embodiment of this application, the second active time is not longer than the first active time; and/or a ratio of a length of the first active time to a length of the second active time is an integer, for example, a result of the length of the first active time/the length of the second active time is an integer, or a result of the length of the second active time/the length of the first active time is an integer; and/or the first active time overlaps at least partially with the second active time, for example, the second active time is partly before or after the first active time, the sending active time overlaps the first active time, or there is an inclusion relation thereof.

In this embodiment of this application, the plurality of active times may include a first active time at least used for receiving and a second active time at least used for sending.

The first active time corresponds to or includes at least a part of resources of a sensing time; and/or the second active time corresponds to or includes at least a part of resources of a selection time.

In this embodiment of this application, the plurality of active times may include a first active time at least used for receiving and a second active time at least used for sending.

At least the part of resources in an overlapped section of the sensing time and the first active time are valid and/or used for sensing, that is, only a channel and/or signal and/or message received within the overlapped section of the first active time and the sensing time is used for sensing; and/or at least the part of resources in an overlapped section of the selection time and the second active time are used for resource determination. In some implementations, only at least a part of a sensing time within the first active time or only at least a part of at least one sensing time within the first active time is valid and/or actually used for sensing; and/or only at least a part of a selection time within the second active time is valid and/or a resource can only be determined within at least the part of the selection time within the second active time.

In this embodiment of this application, the plurality of active times may include a first active time at least used for receiving and a second active time at least used for sending, and the method further includes:

determining a resource within the second active time based on a detection (for example, sensing) result within the first active time. Further, after selecting a resource, the first terminal sends the resource.

Resource selection is used as an example. Measurement is performed in a sensing window (sensing window), and a received Scheduling Assignment (SA) is demodulated and interference measurement is performed within each sensing Transport Time Interval (TTI). UE performs resource selection according to the following steps:

(1) excluding a resource for the UE to send data;

(2) demodulating, by the UE, a received SA to obtain another reserved resource for the UE, and excluding a resource reserved for another UE;

(3) performing energy detection within a sensing window to measure a Reference Signal Strength Indication (RSSI), and excluding, based on a measurement result, a resource bringing much interference; and

(4) randomly selecting, in the selection window, one subframe from 20% resources brining minimal interference for periodic resource reservation.

In this embodiment of this application, the plurality of active times may include the first active time at least used for receiving and a second active time at least used for receiving, and the first active time corresponds to or includes at least a part of resources of the sensing time; and/or the second active time corresponds to or includes at least a part of resources of the sensing time.

In this embodiment of this application, the plurality of active times include the first active time at least used for receiving and a second active time for receiving.

At least the part of resources in an overlapped section of the sensing time and the first active time are valid and/or used for sensing; and/or at least the part of resources in an overlapped section of the sensing time and the second active time are valid and/or used for sensing. In some implementations, only at least a part of a sensing time within the first active time or only at least a part of at least one sensing time within the first active time is valid and/or actually used for sensing; and/or only at least a part of a sensing time within the second active time or only at least a part of at least one sensing time within the second active time is valid and/or actually used for sensing.

In this embodiment of this application, the plurality of active times include the first active time at least used for sending and the second active time at least used for sending, and the first active time corresponds to or includes at least a part of resources of the selection time; and/or the second active time corresponds to or includes at least a part of resources of the selection time.

In this embodiment of this application, the first configuration includes the first active time at least used for sending and the second active time at least used for sending, and at least the part of resources in an overlapped section of the selection time and the first active time are valid and/or used for resource determination; and/or at least the part of resources in an overlapped section of the selection time and the second active time are valid and/or used for resource determination. In some implementations, only at least a part of a selection time within the first active time is valid or a resource can only be determined within at least the part of the selection time within the first active time; and/or only at least a part of a selection time within the second active time is valid and/or a resource can only be determined within at least the part of the selection time within the second active time.

In this embodiment of this application, the first configuration is a specific first configuration, and one or more following pieces of information are received and/or sent within the second active time:

(1) a data packet of a second terminal, where the second terminal and the first terminal are not in a same group; or no connection (for example, an RRC connection or unicast connection) has been established between the second terminal and the first terminal; or the second terminal is another terminal other than a peer terminal of the first terminal, where

there is a negotiated specific first configuration (that may be understood as a dedicated first configuration) between the second terminal and the first terminal;

(2) a broadcast message; and

(3) a message about a specific service,

for example, a message about a business service, a common service, or an unimportant service.

In this embodiment of this application, the second active time is an active time other than the first active time, or is an extension of the first active time.

In other words, the second active time is a new, additional, dynamic, subsidiary, or extended active time other than the first active time.

An implementation is a semi-static or periodic active time in a DRX configuration of the first active time, where the second active time is a new, additional, dynamic, subsidiary, or extended active time. The second active time may be semi-static or periodic, or may be dynamic. For example, the second active time is an active time that needs to satisfy a specific condition to be triggered.

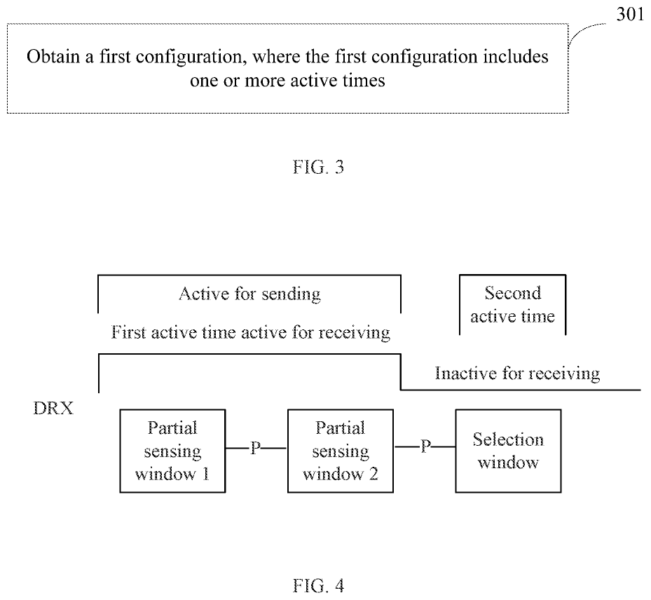

Refer to FIG. 4. The second active time may be understood as an introduced additional active time (Duration 2) used for sending, or may be understood as a part that is divided from an inactive time or Off duration and that can be used for sending. For example, the second active time (Duration 2) is related to the sensing time (a sensing window or a partial sensing window) within the first active time (duration 1), such that the first configuration is aligned with the sensing time (a sensing window or a partial sensing window) and the selection time. In some implementations, the active time (Duration 2) used for sending in the first configuration is aligned with the selection time (selection window), and/or the active time duration 1 that can be used for receiving is aligned with the sensing time.

In this embodiment of this application, the determining a second configuration based on the first configuration includes: determining, based on the active time, a sensing periodicity and/or step size, and a sensing time and/or a selection time in the second configuration.

In this embodiment of this application, a ratio of a periodicity of the second configuration to a periodicity of the first configuration is an integer. For example, the periodicity of the second configuration/the periodicity of the first configuration is an integer, or the periodicity of the first configuration/the periodicity of the second configuration is an integer.

In some implementations, the periodicity of the second configuration is equal to the periodicity of the first configuration.

The periodicity of the second configuration is a time between two sensing times, or is a time between two possible sensing times, or a time between the selection time and a latest sensing time.

In this embodiment of this application, at least a part of resources in an overlapped section of the sensing time and the active time are valid and/or used for sensing; and/or at least a part of resources in an overlapped section of the selection time and the active time are valid and/or used for resource determination.

In this embodiment of this application, the active time is used for determining a location and/or a length of at least one of the sensing time and the selection time.

In this embodiment of this application, the active time overlaps with at least a part of the sensing time and/or the selection time.

An example in which the sensing time is a partial sensing window, and the selection time is a selection window is used.

(1) Only at least a part of the partial sensing window within an active time 1 is valid.

In some implementations, only a bit corresponding to a partial sensing window within DRX On duration 1/a timer 1/the active time 1 is set to 1.

(2) A location and/or a length of the partial sensing window is/are determined relative to the DRX On duration 1/the timer 1/the active time 1.

For example, X % of the DRX On duration 1/the timer 1/the active time 1 is the partial sensing window (which is similar to an overhead indication).

In some implementations, a start of the DRX On duration 1/the timer 1/the active time 1 is a start of the partial sensing window.

In some implementations, the start of the DRX On duration 1/the timer 1/the active time 1 plus an offset is the start of the partial sensing window.

In some implementations, an end of the DRX On duration 1/the timer 1/the active time 1 is an end of the partial sensing window.

In some implementations, the end of the DRX On duration 1/the timer 1/the active time 1 minus an offset is the end of the partial sensing window.

(3) The location and/or the length of the partial sensing window is/are determined relative to DRX duration 2/a timer 2/an active time 2.

In some implementations, a start of the DRX duration 2/the timer 2/the active time 2 is the start of the partial sensing window.

In some implementations, the start of the DRX duration 2/the timer 2/the active time 2 plus an offset is the start of the partial sensing window.

In some implementations, an end of the DRX duration 2/the timer 2/the active time 2 is an end of the partial sensing window.

In some implementations, the end of the DRX duration 2/the timer 2/the active time 2 minus an offset is the end of the partial sensing window.

(4) A location and/or a length of the selection window is/are determined relative to the DRX On duration 1/the timer 1/the active time 1.

In some implementations, the start of the DRX On duration 1/the timer 1/the active time 1 is a start of the selection window.

In some implementations, the start of the DRX On duration 1/the timer 1/the active time 1 plus an offset is the start of the selection window.

In some implementations, the end of the DRX On duration 1/the timer 1/the active time 1 is an end of the selection window.

In some implementations, the end of the DRX On duration 1/the timer 1/the active time 1 minus an offset is the end of the selection window.

(5) The location and/or the length of the selection window is/are determined relative to the DRX duration 2/the timer 2/the active time 2.

In some implementations, the start of the DRX duration 2/the timer 2/the active time 2 is the start of the selection window.

In some implementations, the start of the DRX duration 2/the timer 2/the active time 2 plus an offset is the start of the selection window.

In some implementations, the end of the DRX duration 2/the timer 2/the active time 2 is an end of the selection window.

In some implementations, the end of the DRX duration 2/the timer 2/the active time 2 minus an offset is the end of the selection window.

In this embodiment of this application, a start of the active time is a start of the sensing time; or a start of the active time minus or plus a first offset is a start of the sensing time; or

an end of the active time is an end of the sensing time; or an end of the active time minus or plus a second offset is an end of the sensing time.

In this embodiment of this application, a start of the active time is a start of the selection time; or a start of the active time minus or plus a third offset is a start of the selection time, or

an end of the active time is an end of the selection time; or an end of the active time minus or plus a fourth offset is an end of the selection time.

It can be understood that in this embodiment of this application, the first, second, third, and fourth offsets are not specifically limited.

In this embodiment of this application, a time between sensing times or a time between two possible sensing times is defined as an inactive time (for example, an Off time).

In this embodiment of this application, the method further includes: obtaining a sensing result of at least a part of or all the first configuration; and determining a resource based on the sensing result.

In some implementations, in a case in which a user obtains a plurality of SL DRX configurations, the user may at least use a sensing result (of the DRX On duration 1/the timer 1/the active time 1, and/or the DRX duration 2/the timer 2/the active time 2) of a part of the SL DRX configurations/all the SL DRX configurations for resource selection, reselection, estimation, or re-estimation.

In some implementations, in a case in which a user obtains a plurality of SL DRX configurations, the user may at least perform resource selection, reselection, estimation, or re-estimation (in the DRX On duration 1/the timer 1/the active time 1, and/or the DRX duration 2/the timer 2/the active time 2) in a part of the SL DRX configurations/all the SL DRX configurations.

In this embodiment of this application, the method further includes: determining a resource based on at least the part of or all the first configuration.

In this embodiment of this application, the method further includes:

when determining a resource for initial transmission of one data packet, TB, MAC PDU, or message, determining, within a third active time (for example, a periodic active time, DRX On duration, or the first active time) in the first configuration, the resource for initial transmission of the data packet, TB, MAC PDU, or message;

or

when determining a resource for retransmission of one data packet, TB, MAC PDU, or message, determining, within a fourth active time (for example, a new, additional, dynamic, subsidiary, extended active time, the DRX duration 2, or the second active time) in the first configuration, the resource for retransmission of the data packet, TB, MAC PDU, or message.

It can be understood that the third active time and the fourth active time may be a same active time or different active times in the first configuration.

In this embodiment of this application, the determining a second configuration based on the first configuration includes:

in a case in which an arrival time of the data packet, TB, MAC PDU, or message is not within the active time in the first configuration, adjusting a time for sending or a time for determining the resource for the data packet, TB, MAC PDU, or message, such that a time for sending or a time for selecting the resource for the data packet, TB, MAC PDU, or message overlaps at least partially with the active time.

That is, a time point for an arriving packet, a sent packet, resource selection, or triggering estimation is dynamically adjusted to adapt the first configuration and the second configuration to each other.

In this embodiment of this application, the adjusting a time for sending or a time for determining the resource for the data packet, TB, MAC PDU, or message includes:

adjusting, based on a preset delay time, the time for sending or the time for determining the resource for the data packet, TB, MAC PDU, or message.

For example, in a case in which a time n at which a packet arrives is not within an active time in the first configuration, the packet is stored in a buffer, for example, stored to a time n+M that aligns with a time in the first configuration, such that an impact of a non-periodic service on the second configuration is reduced, where M is a preset time. In some implementations, resource determining is triggered only after the packet is stored to n+M.

In some implementations, a time point n+M after the storage in a buffer is not late than a Packet Delay Budget (PDB) requirement of the packet, that is, n+M is late than n+PDB. In some implementations, a delay time may be M and/or PDB.

In this embodiment of this application, a type of the first configuration includes a first type and a second type.

The first configuration of the first type may include one or more of the following: a dedicated power-saving configuration, a connection-based power-saving configuration, a power-saving configuration with associated terminal information, a power-saving configuration used for unicast and/or multicast, and dynamic DRX, for example, one or more of dedicated SL DRX, connection-based DRX, SL DRX with associated terminal information, DRX used for unicast and/or multicast, and dynamic DRX.

The first configuration of the second type may include one or more of the following: a common power-saving configuration, a no-connection power-saving configuration, a power-saving configuration without associated terminal information, a power-saving configuration used for broadcast and/or multicast, and a periodic power-saving configuration, for example, one or more of common SL DRX, no-connection SL DRX, SL DRX without associated terminal information, DRX used for broadcast and/or multicast, and periodic DRX.

In this embodiment of this application, the first configuration of the first type is used to limit receiving and/or sending related to a corresponding connection (for example, a unicast connection used for negotiating the first configuration or a connection between the first terminal and the second terminal for unicast) of the dedicated first configuration, or the first configuration of the first type is used to limit unicast receiving and/or sending corresponding to the first configuration of the first type.

In this embodiment of this application, an active time that is at least used for receiving and that is in the first configuration of the first type in the first terminal overlaps with at least a part of the sensing time in the second configuration of the first terminal.

In this embodiment of this application, the first terminal receives and/or sends in an overlapped section of the active time at least used for receiving and the sensing time, or the first terminal does not receive and/or send in a non-overlapped section of the active time at least used for receiving and the sensing time.

In this embodiment of this application, an active time that is at least used for sending and that is in the first configuration of the first type in the first terminal overlaps with at least a part of the selection time in the second configuration of the first terminal.

In this embodiment of this application, the first terminal sends and/or receives within the active time at least used for sending or in the overlapped section of the active time at least used for sending and the sensing time; or the first terminal does not send and/or receive beyond the active time at least used for sending or in a section that is not the overlapped section of the active time used for sending and the sensing time.

For example, the active time at least used for receiving of the first terminal (for example, Pedestrian UE (PUE)) needs to match the sensing time of the first terminal, which includes at least one of the following:

1. Within a part of a sensing time within the active time at least used for receiving of the first terminal (for example, PUE), the first terminal may:

(a) receive a Physical Sidelink Control CHannel (PSCCH) and/or a Physical Sidelink Shared CHannel (PSSCH) sent by the second terminal, or

(b) receive and/or send a PSCCH and/or PSSCH for any user.

2. Within an overlapped section of an active time at least used for sending of the second terminal and the sensing time of the first terminal, or within a part of the sensing time of the first terminal, the second terminal:

(a) sends a PSCCH and/or PSSCH for the first terminal; or

(b) receives and/or sends a PSCCH and/or PSSCH for any user.

3. Beyond a part of a sensing time within the active time at least used for receiving of the first terminal (for example, PUE), the first terminal may:

(a) skip receiving a PSCCH and/or PSSCH sent by the second terminal; or

(b) skip receiving and/or sending a PSCCH and/or PSSCH for any user.

4. Beyond an overlapped section of an active time at least used for sending of the second terminal and the sensing time of the first terminal, or beyond a part of the sensing time of the first terminal, the second terminal:

(a) skips sending a PSCCH and/or PSSCH for the first terminal; or

(b) skips receiving and/or sending a PSCCH and/or PSSCH for any user.

In some implementations, the active time at least used for sending of the first terminal (for example, PUE) needs to match the selection time of the first terminal, which includes at least one of the following:

1. Only within the active time at least used for sending of the first terminal or within an overlapped section of the active time at least used for sending and the selection time of the first terminal, the first terminal:

(a) sends a PSCCH and/or PSSCH for the second terminal; or

(b) receives and/or sends a PSCCH and/or PSSCH for any user.

2. Only within an active time at least used for receiving of the second terminal, within an overlapped section of the active time at least used for receiving and the selection time of the second terminal, or within the selection time of the first terminal, the second terminal:

(a) receives a PSCCH and/or PSSCH from the first terminal; or

(b) receives and/or sends a PSCCH and/or PSSCH for any user.

3. Only beyond the active time at least used for sending of the first terminal, or beyond an overlapped section of the active time at least used for sending and the selection time of the first terminal, the first terminal:

(a) skip sending a PSCCH and/or PSSCH for the second terminal; or

(b) skip receiving and/or sending a PSCCH and/or PSSCH for any user.

4. Only beyond an active time at least used for receiving of the second terminal, beyond an overlapped section of the active time at least used for receiving and the selection time of the second terminal, or beyond the selection time of the first terminal, the second terminal:

(a) skip receiving a PSCCH and/or PSSCH from the first terminal, or

(b) skip receiving and/or sending a PSCCH and/or PSSCH for any user.

In this embodiment of this application, the method further includes: sending the second configuration of the first terminal; and/or obtaining the second configuration of the first terminal.

In some implementations, before, when, and/or after the dedicated first configuration is discussed, negotiated, or agreed, the first terminal (for example, PUE) needs to notify a peer terminal (for example, VUE) about the second configuration.

In some implementations, before/when/after the dedicated first configuration is discussed, negotiated, or agreed, the peer terminal (for example, VUE) recommends or indicates, based on a first configuration (of the first terminal), the second configuration to the first terminal. In some implementations, the first terminal uses the second configuration.

In some implementations, the first terminal performs sensing and/or resource selection/reselection based on the second configuration.

In some implementations, when the dedicated first configuration is discussed/negotiated/agreed,

i. The first terminal (for example, PUE) decides the first configuration: the PUE decides the first configuration based on the second configuration of the PUE, for example, the sensing time, and further, in some implementations, the PUE notifies the peer terminal about the first configuration.

ii. The peer terminal (for example, VUE) decides the first configuration: the PUE indicates a related configuration of the sensing time of the PUE, including at least one of a time length limit, a time bitmap, a time at which a packet may arrive, and the like. The VUE recommends or indicates the first configuration as a response.

In this embodiment of this application, the first configuration of the second type is used to limit at least one of the following:

(1) broadcast, multicast, and/or unicast receiving and/or sending related to the first terminal;

(2) broadcast, multicast, and/or unicast receiving and/or sending related to a specific type of terminal (for example, PUE):

(3) broadcast, multicast, and/or unicast receiving and/or sending related to any terminal; and

(4) receiving and/or sending for any transmission.

In this embodiment of this application, the active time at least used for receiving of the first terminal overlaps with at least a part of the sensing time of the first terminal.

In this embodiment of this application, the first terminal receives in the overlapped section of the active time at least used for receiving and the sensing time; or the first terminal does not receive in a section that is not an overlapped section of the active time at least used for receiving and the sensing time.

The active time at least used for receiving of the first terminal (for example, PUE) needs to match the sensing time of the first terminal, which includes at least one of the following:

(1) Within a part of a sensing time within the active time at least used for receiving of the first terminal (for example, PUE), the first terminal may receive a PSCCH and/or a PSSCH sent by another user; or

(2) beyond a part of a sensing time within the active time at least used for receiving of the first terminal (for example, PUE), the first terminal may skip receiving a PSCCH and/or a PSSCH sent by another user.

In this embodiment of this application, the active time at least used for sending of the first terminal overlaps with at least a part of the selection time of the first terminal.

In this embodiment of this application, the first terminal sends within the active time at least used for sending or in the overlapped section of the active time at least used for sending and the selection time; or the first terminal does not send beyond the active time at least used for sending or in a section that is not the overlapped section of the active time at least used for sending and the selection time.

The active time at least used for sending of the first terminal (for example, PUE) needs to match the selection time of the first terminal, which includes at least one of the following:

(1) Only within the active time at least used for sending of the first terminal or within an overlapped section of the active time at least used for sending and the selection time of the first terminal, the first terminal sends a PSCCH and/or a PSSCH for another user; or

(2) only beyond the active time at least used for sending of the first terminal, or beyond an overlapped section of the active time at least used for sending and the selection time of the first terminal, the first terminal skips sending a PSCCH and/or a PSSCH for another user.

In this embodiment of this application, a unit of time of the first configuration may include the following several cases:

(1) The first configuration is based on the physical time:

A part of or all resource pools correspond to a same first configuration.

In some implementations, the first configuration is invalid for a part of resource pools, that is, a user never ceases to sense, monitor, and/or transmit a target object in these resource pools.

In some implementations, the first configuration is valid for all resource pools, that is, a user senses, monitors, and/or transmits a target object based on an active time in these resource pools.

In some implementations, a time length of the first configuration is the physical time, for example, a physical length, or a quantity of physical time units.

The logical time and the physical time are introduced below.

A part of Uu resources may be used for an SL. These resources used for the SL are re-numbered, which may be understood as numbering based on the logical time. For example, a slot 1/3 in 10 continuous slots (whose physical-time numbers are assumed to be slot 0 to slot 9) is used for the SL, a physical-time number thereof is slot 1/3, and a logical-time number is slot 0/1, the physical time includes continuous time units, while time units in the logical time may be discontinuous or may be continuous.

In some implementations, an active time and an inactive time corresponding to the first configuration are physical times, for example, physical lengths, or quantities of physical time units.

In some implementations, an offset of the active time corresponding to the first configuration is an offset (of the physical time) relative to a preset Direct Frame Number (DFN) or a System Frame Number (SFN).

In some implementations, the offset is an offset (the physical time) relative to DFN #0/SFN #0. For example, a start of On duration has an offset of N physical slots relative to DFN #0/SFN #0.

(2) The first configuration is based on the logical time:

Each resource pool has a corresponding first configuration.

In some implementations, first configurations corresponding to some resource pools may be the same. For example, IDs of the corresponding first configurations are the same.

In some implementations, at most one resource pool can have a corresponding first configuration. For example, a user has eight resource pools, and at most one resource pool can have a corresponding first configuration.

In some implementations, the user can transmit an SL only in the resource pool.

In some implementations, in a case in which N resource pools can have corresponding first configurations, where N is greater than 1. For example, a user has eight resource pools, each resource pool can have a corresponding first configuration, and the user can select only one resource pool for transmission.

In some implementations, the PUE cannot dynamically switch a resource pool, or only one resource pool can be configured for the PUE, or only one resource pool with a first configuration can be configured for the PUE.

An example in which the first configuration is SL DRX is used. The foregoing description can solve a problem that power cannot be saved in DRX based on the logical time due to a plurality of resource pools for Time-Division Multiplexing (TDM).

In some implementations, the time length of the first configuration is the logical time for transmission, for example, a logical length, or a quantity of logical time units (different times may belong to different resource pools).

In some implementations, the time length of the first configuration is the logical time in a resource pool corresponding to the first configuration, for example, a logical length, or a quantity of logical time units.

In some implementations, an active time and an inactive time corresponding to the first configuration are logical times, for example, logical lengths, or quantities of logical time units.

In some implementations, one first configuration based on the logical time corresponds to a plurality of resource pools, and timekeeping is performed on the plurality of resource pools using drx-ShortCycleTimer.

In some implementations, different first configurations based on the logical time correspond to different resource pools, and each of the resource pools is counted based on drx-ShortCycleTimer.

In some implementations, the offset of the active time (for example, On duration) of the first configuration is:

(a) An offset (of the logical time) relative to a resource, in a resource pool (pool) corresponding to the first configuration, closest to a preset DFN/SFN, or an offset relative to the first sidelink resource in a resource pool corresponding to the first configuration after the DFN/SFN is preset.

In some implementations, the offset is an offset (of the logical time) relative to a resource, in the resource pool corresponding to the first configuration, closest to the DFN #0/SFN #0. For example, the first configuration is SL DRX. The SL DRX is associated with a pool 1, and an offset is an offset relative to an SL slot in the pool 1, in N SL slots (in the resource pool), closest to DFN #0/SFN #0; or an offset is an offset relative to the first SL slot in the pool 1, in N SL slots (in the resource pool), after DFN #0/SFN #0, where N is a natural number.

(b) An offset of (the logical time) relative to a preset DFN/SFN.

In some implementations, the offset is an offset (the logical time) relative to DFN #0/SFN #0, for example, an offset of N SL slots relative to DFN #0.

A resource corresponding to the offset (the logical time) may be a resource that can be used for an SL (including a UL slot that satisfies a quantity of symbols required for an SL, but the resource may not actually used for an SL); or may be a resource that is actually used for an SL.

In some implementations, a resource corresponding to the offset (the logical time) may belong to a first resource pool, where the first resource pool may be any resource pool.

In some implementations, a resource corresponding to the offset (the logical time) is an SL slot in a resource pool corresponding to the SL DRX.

In some implementations, a resource corresponding to the offset (the logical time) includes a slot having an S-SSB or excludes a slot having an S-SSB.

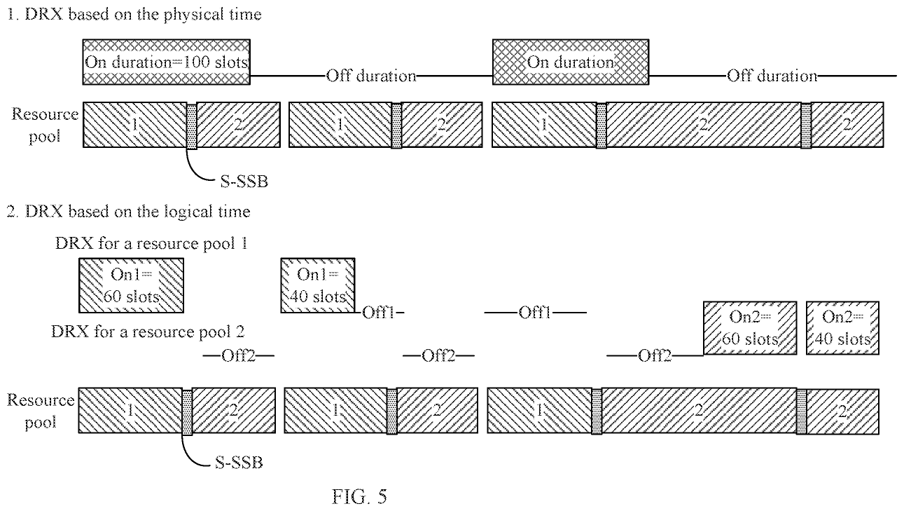

FIG. 5 shows a case in which the first configuration is based on the physical time or the logical time.

(3) One part of a time/time length/timer in the first configuration is based on the logical time, and the other part of the time/time length/timer is based on the physical time.

In some implementations, a HARQ RTT timer, a DRX-retransmission timer, and/or a DRX-inactivity timer is/are defined based on the logical time, and On duration and/or Off duration is/are defined based on the physical time.

A length of the timer may be a length of (a corresponding logical or physical time of) a CSI latency bound or a length of (a corresponding logical or physical time of) T400.

In this embodiment of this application, in (1) to (3) described above, the method may further include: receiving first information, where the first information indicates a type of the active time and/or the inactive time in the first configuration.

In this embodiment of this application, the active time overlaps at least partially with the sensing time and/or the selection time, to prevent lost transmission in a case of mismatch and ensure transmission reliability.

The following describes the embodiments of this application in conjunction with embodiment 1 to embodiment 5.

### Embodiment 1

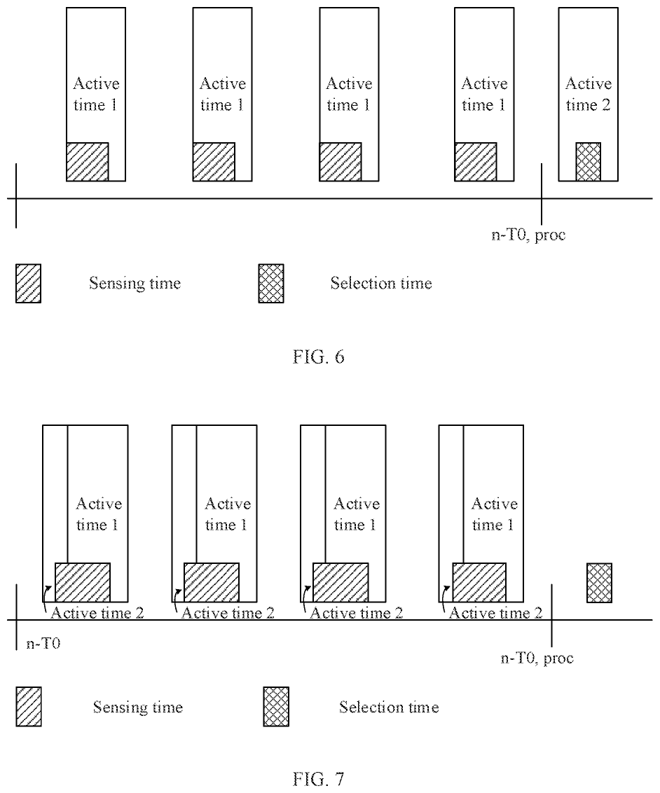

Refer to FIG. 6. Resource selection, reselection, estimation, re-estimation, or sending is performed within a selection time within the active time 2 based on a sensing result in four active times 1.

### Embodiment 2

Refer to FIG. 7. Resource selection, reselection, estimation, re-estimation, or sending is performed within a selection time based on a sensing result in the active time 1 and the active time 2.

### Embodiment 3

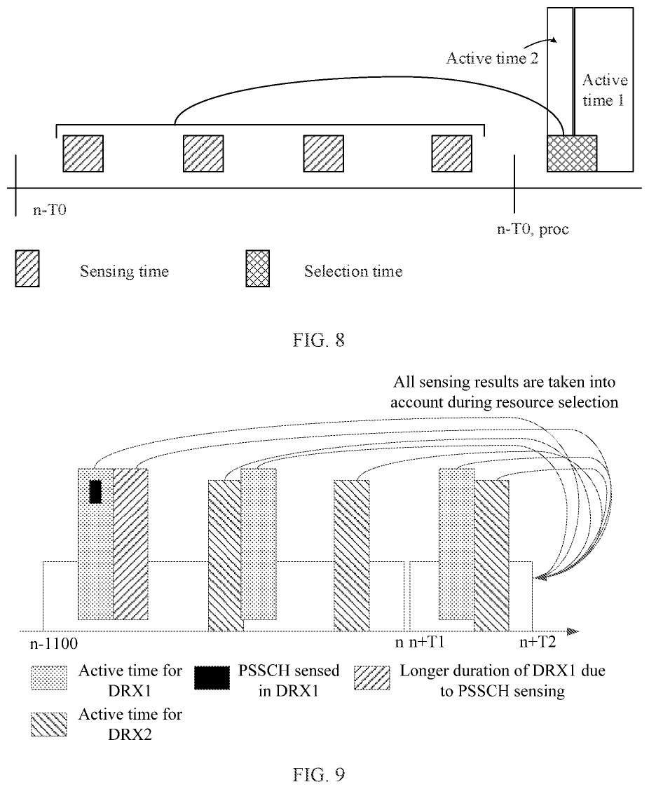

Refer to FIG. 8. Resource selection, reselection, estimation, re-estimation, or sending is performed within a selection time within the active time 1 and the active time 2 based on a sensing result.

### Embodiment 4

Refer to FIG. 9. A user obtains a plurality of SL DRX configurations, and the user may at least use a sensing result of at least a part of the SL DRX or all the SL DRX for resource election, reselection, estimation, or re-estimation.

The user selects a resource within a selection window [n+T1, n+T2] based on a sensing result of an active time (On duration) in an SL DRX configuration 1 and a sensing result of an active time in an SL DRX configuration 2.

### Embodiment 5

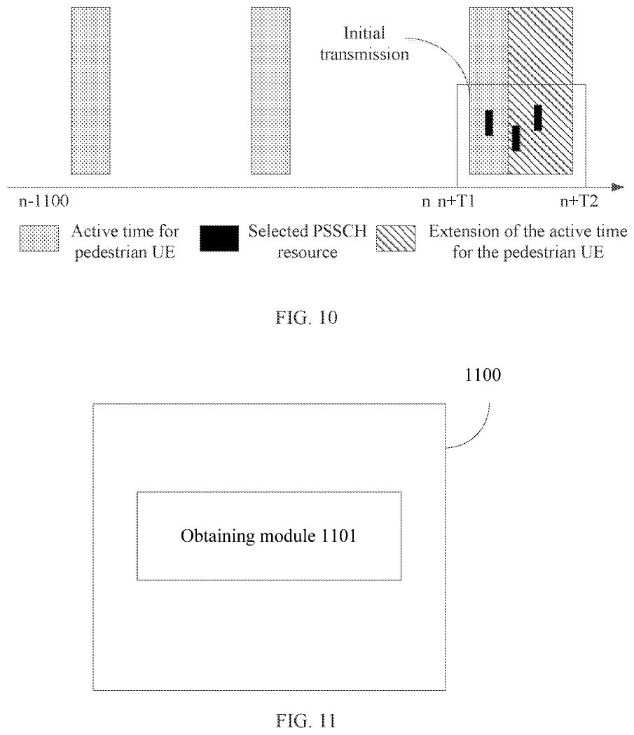

Refer to FIG. 10. When selecting a resource for initial transmission of one TB/PDU/data/packet, resource selection, resource reselection, estimation, or re-estimation needs to be performed within the third active time, for example, a periodic DRX active time. For example, resource selection, resource reselection, estimation, or re-estimation is performed within a periodic active time. A resource used for initial transmission is selected within the fourth active time. For example, a resource used for retransmission is selected within an extended part of active time.

Refer to FIG. 11. This embodiment of this application provides a configuration apparatus, applied to a first terminal. The apparatus 1100 includes:

an obtaining module 1101, configured to obtain a first configuration, where the first configuration includes one or more active times.

In this embodiment of this application, the apparatus 1100 further includes a first determining module, configured to determine a second configuration based on the first configuration, where the second configuration includes a sensing time and/or a selection time.

In this embodiment of this application, a periodicity of the first configuration is a common multiple or a common divisor of a first periodicity; or a periodicity of the first configuration corresponds to a first periodicity; or a periodicity of the first configuration corresponds to a first periodicity range, where

the first periodicity includes at least one of the following: (1) a reservation periodicity; (2) a sensing periodicity and/or step size; and (3) a feedback resource periodicity.

In the embodiments of this application, the plurality of active times at least include a first active time and a second active time.

In this embodiment of this application, the first active time is used for receiving and/or sending; and/or the second active time is used for receiving and/or sending.

In this embodiment of this application, the second active time is not longer than the first active time; and/or a ratio of a length of the first active time to a length of the second active time is an integer; and/or the first active time overlaps at least partially with the second active time.

In this embodiment of this application, the plurality of active times include the first active time at least used for receiving and the second active time at least used for sending;

the first active time corresponds to or includes at least a part of resources of a sensing time; and/or the second active time corresponds to or includes at least a part of resources of a selection time.

In this embodiment of this application, the plurality of active times include the first active time at least used for receiving and the second active time at least used for sending; and

at least the part of resources in an overlapped section of the sensing time and the first active time are valid and/or used for sensing; and/or at least the part in an overlapped section of the selection time and the second active time is used for resource determination.

In this embodiment of this application, the plurality of active times include the first active time at least used for receiving and the second active time at least used for sending, and the apparatus 1100 further includes:

a second determining module, configured to determine a resource within the second active time based on a sensing result within the first active time.

In this embodiment of this application, the plurality of active times include the first active time at least used for receiving and the second active time at least used for receiving, and the first active time corresponds to or includes at least a part of resources of the sensing time; and/or the second active time corresponds to or includes at least a part of resources of the sensing time.

In this embodiment of this application, the plurality of active times include the first active time at least used for receiving and a second active time for receiving.

At least the part of resources in an overlapped section of the sensing time and the first active time are valid and/or used for sensing; and/or at least the part of resources in an overlapped section of the sensing time and the second active time are valid and/or used for sensing.

In this embodiment of this application, the plurality of active times include the first active time at least used for sending and the second active time at least used for sending, where

the first active time corresponds to or includes at least a part of resources of the selection time; and/or the second active time corresponds to or includes at least a part of resources of the selection time.

In this embodiment of this application, the first configuration includes the first active time used for sending and the second active time used for sending, where at least the part of resources in an overlapped section of the selection time and the first active time are valid and/or used for resource determination; and/or at least the part of resources in an overlapped section of the selection time and the second active time are valid and/or used for resource determination.

In this embodiment of this application, the first configuration is a specific first configuration, and one or more following pieces of information are received and/or sent within the second active time:

(1) a data packet of a second terminal, where the second terminal and the first terminal are not in a same group; or no connection has been established between the second terminal and the first terminal; or the second terminal is another terminal other than a peer terminal of the first terminal;

(2) a broadcast message; and

(3) a message about a specific service.

In this embodiment of this application, the second active time is an active time other than the first active time, or is an extension of the first active time.

In this embodiment of this application, the first determining module is further configured to determine, based on the active time, a sensing periodicity, a sensing step size, a sensing time and/or a selection time in the second configuration.

In this embodiment of this application, a ratio of the sensing periodicity and/or step size to the active time is an integer.

In this embodiment of this application, at least a part of resources in an overlapped section of the sensing time and the active time are valid and/or used for sensing; and/or at least a part of resources in an overlapped section of the selection time and the active time are valid and/or used for resource determination.

In this embodiment of this application, the active time is used for determining a location and/or a length of at least one of the sensing time and the selection time.

In some implementations, the active time overlaps with at least a part of the sensing time and/or the selection time.

In this embodiment of this application, a start of the active time is a start of the sensing time; or a start of the active time minus or plus a first offset is a start of the sensing time; or

an end of the active time is an end of the sensing time; or an end of the active time minus or plus a second offset is an end of the sensing time.

In this embodiment of this application, a start of the active time is a start of the selection time; or a start of the active time minus or plus a third offset is a start of the selection time; or

an end of the active time is an end of the selection time; or an end of the active time minus or plus a fourth offset is an end of the selection time.

In this embodiment of this application, the apparatus 1100 further includes:

a second obtaining module, configured to: obtain a sensing result of at least a part of or all the first configuration; and determine a resource based on the sensing result.

In this embodiment of this application, the apparatus 1100 further includes: a third determining module, configured to determine a resource based on at least the part of or all the first configuration.

In this embodiment of this application, the apparatus 1100 further includes a fourth determining module, configured to: when determining a resource for initial transmission of one data packet, TB, MAC PDU, or message, determine, within a third active time in the first configuration, the resource for initial transmission of the data packet, TB, MAC PDU, or message; or when determining a resource for retransmission of one data packet, TB, MAC PDU, or message, determine, within an active time in the first configuration, the resource for retransmission of the data packet, TB, MAC PDU, or message.

In this embodiment of this application, the first determining module is further configured to: in a case in which an arrival time of the data packet, TB, MAC PDU, or message is not within the fourth active time in the first configuration, adjust a time for sending or a time for determining the resource for the data packet, TB, MAC PDU, or message, such that a time for sending or a time for selecting the resource for the data packet, TB, MAC PDU, or message overlaps at least partially with the active time.

In this embodiment of this application, the adjusting a time for sending or a time for determining the resource for the data packet, TB, MAC PDU, or message includes:

adjusting, based on a preset delay time, the time for sending or the time for determining the resource for the data packet, TB, MAC PDU, or message.

In this embodiment of this application, a type of the first configuration includes a first type and a second type.

In this embodiment of this application, the first configuration of the first type is used to limit receiving and/or sending related to a corresponding connection of the dedicated first configuration, or the first configuration of the first type is used to limit unicast receiving and/or sending corresponding to the first configuration of the first type.

In this embodiment of this application, an active time that is at least used for receiving and that is in the first configuration of the first type in the first terminal overlaps with at least a part of the sensing time in the second configuration of the first terminal.

In this embodiment of this application, the first terminal receives and/or sends in an overlapped section of the active time at least used for receiving and the sensing time; or the first terminal does not receive and/or send in a non-overlapped section of the active time at least used for receiving and the sensing time.

In this embodiment of this application, an active time that is at least used for sending and that is in the first configuration of the first type in the first terminal overlaps with at least a part of the selection time in the second configuration of the first terminal.

In this embodiment of this application, the first terminal sends and/or receives within the active time at least used for sending or in the overlapped section of the active time at least used for sending and the sensing time; or the first terminal does not send and/or receive beyond the active time at least used for sending or in a section that is not the overlapped section of the active time used for sending and the sensing time.

In this embodiment of this application, the apparatus 1100 further includes: a sending module, configured to: send the second configuration of the first terminal; and/or obtain the second configuration of the first terminal.

In this embodiment of this application, the first configuration of the second type is used to limit at least one of the following:

(1) broadcast, multicast, and/or unicast receiving and/or sending related to the first terminal;

(2) broadcast, multicast, and/or unicast receiving and/or sending related to a specific type of terminal;

(3) broadcast, multicast, and/or unicast receiving and/or sending related to any terminal; and

(4) receiving and/or sending for any transmission.

In this embodiment of this application, the active time at least used for receiving of the first terminal overlaps with at least a part of the sensing time of the first terminal.

In this embodiment of this application, the first terminal receives and/or sends in the overlapped section of the active time at least used for receiving and the sensing time, or the first terminal does not receive and/or send in a section that is not an overlapped section of the active time at least used for receiving and the sensing time.

In this embodiment of this application, the active time at least used for sending of the first terminal overlaps with at least a part of the selection time of the first terminal.

In this embodiment of this application, the first terminal sends and/or receives within the active time at least used for sending or in the overlapped section of the active time at least used for sending and the selection time; or the first terminal does not send and/or receive beyond the active time at least used for sending or in a section that is not the overlapped section of the active time at least used for sending and the selection time.

In this embodiment of this application, a type of the active time and/or the inactive time in the first configuration is/are the physical time; and

an offset of the active time is an offset relative to a preset DFN or SFN.

In this embodiment of this application, a type of the active time and/or the inactive time in the first configuration is/are the logical time, and

a quantity of resource pools of the first terminal that are configured with the first configuration is N, where N is greater than or equal to 1, and the first terminal performs transmission in one resource pool configured with the first configuration.

In this embodiment of this application, an offset of the active time is any one of the following:

(1) an offset relative to a sidelink resource, in a resource pool corresponding to the first configuration, closest to a preset direct frame number or a preset system frame number;

(2) an offset relative to the first sidelink resource, in a resource pool corresponding to the first configuration, after the preset direct frame number or the system frame number is preset; and

(3) an offset relative to the preset direct frame number or the preset system frame number.

In this embodiment of this application, a resource corresponding to the offset may belong to a first resource pool (the first resource pool may be any resource pool); or a resource corresponding to the offset is a sidelink resource in a resource pool corresponding to the first configuration; or a resource corresponding to the offset includes a resource having a sidelink synchronization signal block, or includes a resource other than a slot having a sidelink synchronization signal block.

In this embodiment of this application, the apparatus 1100 further includes a receiving module, configured to receive first information, where the first information indicates a type of the active time and/or the inactive time in the first configuration.

The processing apparatus provided in this embodiment of this application can implement the processes implemented in the method embodiment shown in FIG. 3. To avoid repetition, details are not provided herein again.

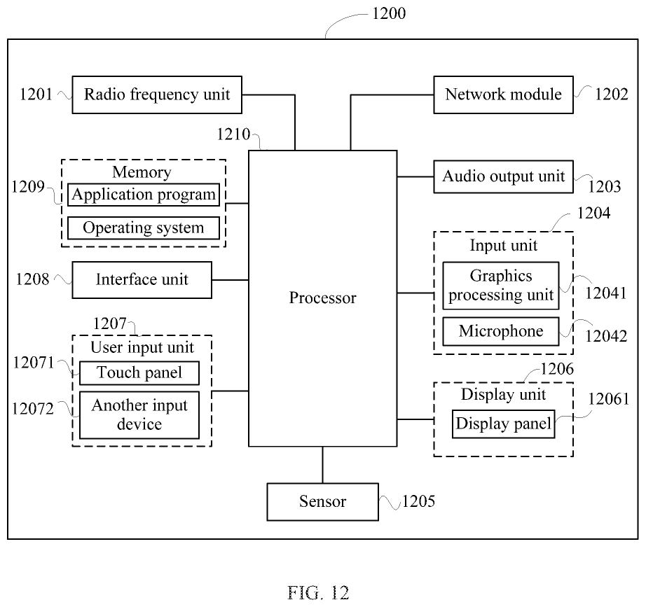

FIG. 12 is a schematic diagram of a hardware structure of a terminal according to an embodiment of this application.

The terminal 1200 includes but is not limited to components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

It may be understood by a person skilled in the art that the terminal 1200 may further include a power supply (such as a battery) that supplies power to each component. The power supply may be logically connected to the processor 1210 by using a power management system, to implement functions such as charging, discharging, and power consumption management by using the power management system. The terminal structure shown in FIG. 12 constitutes no limitation on the terminal, and the terminal may include more or fewer components than those shown in the figure, or combine some components, or have different component arrangements. Details are not provided herein.

It should be understood that, in the embodiments of this application, the input unit 1204 may include a Graphics Processing Unit (GPU) 12041 and a microphone 12042, and the graphics processing unit 12041 processes image data of a still picture or video obtained by an image capture apparatus (such as a camera) in a video capture mode or an image capture mode. The display unit 1206 may include a display panel 12061, and the display panel 12061 may be configured in a form of a liquid crystal display, an organic light-emitting diode, or the like. The user input unit 1207 includes a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not provided herein.

In this embodiment of this application, the radio frequency unit 1201 receives downlink data from a network side device and then sends the downlink data to the processor 1210 for processing; and sends uplink data to the network side device. Usually, the radio frequency unit 1201 includes but is not limited to an antenna, at least one amplifier, a transceiver, a coupler, a low noise amplifier, a duplexer, and the like.

The memory 1209 may be configured to store a software program or an instruction and various data. The memory 1209 may mainly include a program or instruction storage area and a data storage area. The program or instruction storage area may store an operating system, and an application or an instruction required by at least one function (for example, a sound playing function or an image playing function). In addition, the memory 1209 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory. For example, at least one disk storage component, a flash memory component, or another non-volatile solid-state storage component.

The processor 1210 may include one or more processing units. In some implementations, an application processor and a modem processor may be integrated into the processor 1210. The application processor mainly processes an operating system, a user interface, an application, an instruction, or the like. The modem processor mainly processes wireless communication, for example, a baseband processor. It can be understood that, in some implementations, the modem processor may not be integrated into the processor 1210.

The terminal provided in this embodiment of this application can implement the processes implemented in the method embodiment shown in FIG. 3, and achieve a same technical effect. To avoid repetition, details are not provided herein again.

An embodiment of this application further provides a program product. The program product is stored in a non-volatile storage medium, and the program product is executed by at least one processor to implement the steps of the processing method shown in FIG. 2.

An embodiment of this application further provides a readable storage medium. The readable storage medium stores a program or an instruction, and when the program or the instruction is executed by a processor, the processes of the method embodiment of FIG. 2 are implemented. To avoid repetition, details are not provided herein again.

The processor is a processor in the terminal in the above embodiment. The readable storage medium includes a computer-readable storage medium such as a Read-Only Memory (ROM), a Random Access Memory (RAM), a magnetic disk, an optical disc, or the like.

An embodiment of this application further provides a chip. The chip includes a processor and a communication interface, the communication interface is coupled to the processor, and the processor is configured to run a program or an instruction of a network side device to implement the processes of the method embodiment of FIG. 2. To avoid repetition, details are not provided herein again.

It should be understood that the chip mentioned in the embodiment of this application can also be called a system-level chip, a system chip, a chip system, or a system on chip.

It can be understood that the embodiments described in the present disclosure may be implemented by hardware, software, firmware, middleware, microcode, or a combination thereof. For hardware implementation, a module, a unit, a submodule, a subunit, or the like may be implemented in one or more Application Specific Integrated Circuits (ASIC), a Digital Signal Processing (DSP), a DSP Device (DSPD), a Programmable Logic Device (PLD), a Field-Programmable Gate Array (FPGA), a general purpose processor, a controller, a microcontroller, a microprocessor, another electronic unit configured to perform the functions described in this application, or a combination thereof.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementation manners, a person skilled in the art may understand that the method in the foregoing embodiment may be implemented by software in addition to a necessary universal hardware platform or by hardware only. Based on such understanding, the technical solutions of this application essentially, or the part contributing to the prior art may be implemented in a form of a software product. The computer software product is stored in a storage medium (for example, a ROM/RAM, a magnetic disk, or a compact disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementation manners. The foregoing specific implementation manners are merely schematic instead of restrictive. Under enlightenment of this application, a person of ordinary skills in the art may make many forms without departing from aims and the protection scope of claims of this application, all of which fall within the protection scope of this application.

What is claimed is:

1. A processing method, performed by a first terminal, wherein the method comprises:
obtaining a first configuration, wherein the first configuration comprises one or more active times.

2. The method according to claim 1, further comprising:
determining a second configuration based on the first configuration, wherein the second configuration comprises a sensing time or a selection time.

3. The method according to claim 1, wherein
a periodicity of the first configuration is a common multiple or a common divisor of a first periodicity;
a periodicity of the first configuration corresponds to a first periodicity; or
a periodicity of the first configuration corresponds to a first periodicity range, wherein
the first periodicity comprises at least one of the following:
a reservation periodicity;
a sensing periodicity or step size; or
a feedback resource periodicity.

4. The method according to claim 1, wherein the plurality of active times comprise at least a first active time and a second active time, and
wherein the first active time is used for receiving or sending, or the second active time is used for receiving or sending.

5. The method according to claim 4, wherein the second active time is not longer than the first active time;
a ratio of a length of the first active time to a length of the second active time is an integer; or
the first active time overlaps at least partially with the second active time.

6. The method according to claim 4, wherein the active time comprises the first active time at least used for receiving and the second active time at least used for sending;
wherein the first active time corresponds to or comprises at least a part of resources of the sensing time; or
wherein the second active time corresponds to or comprises at least a part of resources of the selection time.

7. The method according to claim 4, wherein the active time comprises the first active time at least used for receiving and the second active time at least used for sending, and the method further comprises:
determining a resource within the second active time based on a sensing result within the first active time.

8. The method according to claim 4, wherein the first configuration is a specific first configuration, and one or more of the following pieces of information are received or sent within the second active time:
a data packet of a second terminal, wherein the second terminal and the first terminal are not in a same group; that no connection has been established between the second terminal and the first terminal; or the second terminal is another terminal other than a peer terminal of the first terminal;
a broadcast message; and
a message about a specific service.

9. The method according to claim 4, wherein the second active time is an active time other than the first active time, or is an extension of the first active time.

10. The method according to claim 1, wherein the determining a second configuration based on the first configuration comprises:
determining, based on the active time, a sensing periodicity, or step size, and a sensing time, or a selection time in the second configuration.

11. The method according to claim 1, wherein the method further comprises:
obtaining a sensing result of at least a part of or all the first configuration; and
determining a resource based on the sensing result, or at least the part of or all the first configuration.

12. The method according to claim 1, wherein the method further comprises:
when determining a resource for initial transmission of one data packet, Transport Block (TB), Media Access Control Protocol Data Unit (MAC PDU), or message, determining, within a third active time of the first configuration, the resource for initial transmission of the data packet, TB, MAC PDU, or message; or
when determining a resource for retransmission of one data packet, TB, MAC PDU, or message, determining, within a fourth active time of the first configuration, the resource for retransmission of the data packet, TB, MAC PDU, or message.

13. The method according to claim 2, wherein the determining a second configuration based on the first configuration comprises:
in a case in which an arrival time of the data packet, Transport Block (TB), Media Access Control Protocol Data Unit (MAC PDU), or message is not within the active time of the first configuration, adjusting a time for sending or a time for determining the resource for the data packet, TB, MAC PDU, or message, such that a time for sending or a time for selecting the resource for the data packet, TB, MAC PDU, or message overlaps at least partially with the active time.

14. The method according to claim 1, wherein
a type of the first configuration comprises a first type and a second type.

15. The method according to claim 14, wherein the first configuration of the first type is used for receiving or sending related to a corresponding connection of the dedicated first configuration; or
the first configuration of the first type is used for unicast receiving or sending corresponding to the first configuration of the first type.

16. The method according to claim 14, wherein the first configuration of the second type is used for at least one of the following:
broadcast, multicast, or unicast receiving or sending related to the first terminal;
broadcast, multicast, or unicast receiving or sending related to a specific type of terminal;
broadcast, multicast, or unicast receiving or sending related to any terminal; or
receiving or sending for any transmission.

17. The method according to claim 1, wherein a type of the active time in the first configuration is the physical time; and
an offset of the active time is an offset relative to a preset direct frame number or a preset system frame number.

18. The method according to claim 1, wherein a type of the active time in the first configuration is the logical time; and
a quantity of resource pools of the first terminal that are configured with the first configuration is N, wherein N is greater than or equal to 1, and the first terminal performs transmission in one resource pool configured with the first configuration.

19. The method according to claim 1, wherein an offset of the active time is any one of the following:
an offset of relative to a sidelink resource, in a resource pool corresponding to the first configuration, closest to a preset direct frame number or a preset system frame number;
an offset relative to the first sidelink resource, in a resource pool corresponding to the first configuration, after the direct frame number or the system frame number is preset; or
an offset relative to the preset direct frame number or the preset system frame number.

20. A terminal, comprising:
a memory storing computer-readable instructions; and
a processor coupled to the memory and configured to execute the computer-readable instructions, wherein the computer-readable instructions, when executed by the processor, cause the processor to perform operations comprising:
obtaining a first configuration, wherein the first configuration comprises one or more active times.
